(19) United States
(12) Patent Application Publication
(10) Pub. No.: US 2017/0363927 A1
(43) Pub. Date: Dec. 21, 2017

(54) DISPLAY ARRANGEMENT AND METHOD FOR DISPLAYING INFORMATION

(71) Applicants: Alexander van Laack, Aachen (DE); Andreas Deubzer, Koln (DE); Ruddy Cittadini, Koln (DE)

(72) Inventors: Alexander van Laack, Aachen (DE); Andreas Deubzer, Koln (DE); Ruddy Cittadini, Koln (DE)

(21) Appl. No.: 15/625,507

(22) Filed: Jun. 16, 2017

(30) Foreign Application Priority Data
Jun. 17, 2016 (DE) 10 2016 111 159.7

(51) Int. Cl. G02F 1/153

(52) U.S. Cl. CPC G02F 1/153; G02F 2201/44; G02F 2203/66

(57) ABSTRACT

The disclosure is related to an arrangement in which an electrical tinting film is arranged between the display and the cover surface to provide a dead front appearance. The electrical tinting film is opaque without an externally applied voltage and the information made available on the display is not visible, and wherein the electrical tinting film becomes transparent by the application of a voltage and the information made available on the display becomes visible.

### CROSS-REFERENCE TO RELATED APPLICATION

This application claims priority to German Patent Application No. 10 2016 111 159.7 filed Jun. 17, 2016, and entitled “Display Arrangement and Method for Displaying Information,” which is herein incorporated by reference.

### BACKGROUND

The disclosure relates to a display arrangement consisting of a display for showing information, and of a cover surface arranged above a surface of the display.

The disclosure also relates to a method for displaying information, in which information is displayed on an available display.

In many areas of technology displays are used to show or display information in many embodiments. Devices and systems such as hi-fi devices, computers, household devices or machines and systems in production workplaces can be cited as examples. Even the use of such display arrangements in motor vehicles is customary in order to display to the driver information about a driving state of the motor vehicle such as the speed, engine revolutions, engine temperature, gas tank level or additional information about structural components in the motor vehicle, for example, a sound system, air conditioning system or a navigation system and many others.

In addition to the pure showing of information, the design of a display or of a display arrangement is becoming more and more important. Original equipment manufacturers, abbreviated as OEM, try to adapt a display used, for example, in a motor vehicle to a motor vehicle design and to allow the display to appear, for example, in a white color.

The displays used in the prior art appear in a turned-off, currentless, non-illuminated state but in a dark, usually black color. In order to change this state, a plane in a white color could be arranged in front of the actual display. In this case the white plane should have only a very small thickness and the illuminating power of the display should be so great that the layer arranged in front is penetrated by radiation or is transilluminated.

Since in such an arrangement heavy losses must be accepted regarding the quality of the representation, this way of making a display arrangement with a white appearance image was not successful.

U.S. Pat. No. 8,390,552 discloses a special display which makes a white image screen available in a turned-off state. The focus of the description is on the reduction of visible defects in this active-matrix liquid crystal display, in particular when showing an almost completely white display in an operating state of the special display.

U.S. Pat. No. 8,130,240 describes a display with the possibility for a gamma calibration, wherein the display is manufactured from three superposed layers. The display comprises a lower layer in which bright and dark lines alternate, a second or middle layer which is gray, and a third or top layer which is constructed as a progressive layer and merges gradually from completely transparent to translucent.

A display is known from U.S. Pat. No. 9,093,049 which comprises a first electrical chrome film layer with a first electrical chrome device. When a voltage is applied, the film layer appears white or transparent. In addition, the display comprises a second electrical chrome film layer with a second electrical chrome device which appears black or transparent upon application of a voltage.

EP 1 006 393 B1 teaches a clock with a liquid crystal display field which can display at least either time information or calendar information. The liquid crystal display field comprises a TN liquid crystal cell with nematic liquid crystals rotated through approximately 90° which are enclosed between a pair of transparent substrates each comprising transparent electrodes, comprises a first polarization film which is arranged on the visible side of the TN liquid crystal cell, and comprises a second polarization film, a retarding film for circularly polarized light, a cholesteric liquid crystal polymer layer, a transparent, light-absorbing part and a backlight which are successively arranged on a side of the TN liquid crystal cell opposite the visible side of the TN liquid crystal cell.

DE 10 2015 010 213 A1 discloses a viewing field adjustment device for a motor vehicle, which comprises several viewing field adjustment areas which are provided on an upper edge part and/or on a lower edge part and/or on right and left side edge parts of a windshield window. The viewing field adjustment areas are configured in such a manner that that they can be switched between a transparent state in which a view to the front is ensured and between a translucent or non-transparent state in which the view to the front is limited.

This prior art has the disadvantage that a special display or partially additional structural components such as an electrical chrome film or a progressive layer for making available a display which appears white when turned off are required.

The disclosure therefore has the problem of making a display arrangement available which comprises a surface which appears white in a turned-off state, wherein economical standard displays are used in the display arrangement and the display arrangement is simple to manufacture and to operate.

The problem is solved by subject matter with the features according to Claim 1 of the independent claims. Further developments are indicated in the dependent Claims 2 to 5.

It is provided that an electrical tinting film and a cover surface are arranged above a display surface. An LCD display, TFT display or an OLED display, all of which are known from the prior art, can be used here as display.

The electrical tinting film is selected in the color in which the display arrangement of the disclosure should appear in its currentless or turned-off state. In the example a white electrical tinting film is used in order to make available a display arrangement which appears white.

The electrical tinting film preferably in a white color shade without an applied voltage and is opaque so that an observer of the display arrangement cannot see the display with any represented information arranged under the tinting film.

As soon as an appropriate voltage is put on the electrical tinting film, the optical qualities of the tinting film change and the tinting film becomes transparent. In this state an observer can recognize information displayed on the display through the cover surface and the tinting film.

A special embodiment of the display arrangement provides that the cover surface is designed in such a manner that its optical qualities change starting from the center of the cover surface toward the edge. In this manner an image area is made available around the cover surface which appears opaque and white.

The area appearing white cooperates with the white, electrical tinting film and improves the total white impression of the display arrangement. This is especially the case when the electrical tinting film underneath the cover surface has a lesser dimension than the cover surface. This is also the case if the observer is looking onto the display arrangement from a lateral position.

In addition, it is provided that the cover surface and the electrical tinting film are connected to one another by using a method of optical bonding in which the space between the cover surface and the electrical tinting film are filled with a mass adapted in its refraction index. This air-free filling of the intermediate space makes it possible to manufacture displays with good optical qualities and an improved contrast ratio.

The method of optical bonding can also be used between the electrical tinting film and the surface of the display.

A particular advantage of the disclosure is the fact that standard displays such as TFT displays, LCD displays or OLED displays which are commercially available and customarily appear dark or black in the turned-off state can be used in the described display arrangement. Therefore, the display arrangement of the disclosure can be designed to be very flexible and is economical to manufacture.

The problem is also solved by a method with the features according to Claim 6 of the independent claims. Further developments are indicated in the dependent Claims 7 to 12.

The display arrangement of the disclosure is made available with an electrical tinting film which makes it possible to see the display arranged under the tinting film by applying a voltage, or to prevent the viewing of the display arranged under the tinting film without an applied voltage.

Therefore, by using different customary displays which offer a dark or black view in the turned-off state, a display arrangement in the color of the electrical tinting film such as, for example, white can be made available.

It is provided for the protection of the electrical tinting film to arrange a cover surface above the tinting film. In an advantageous further development this cover surface is constructed to be transparent in the middle and with, for example, a circumferential, opaque edge area.

An optical bonding method is advantageously used to connect the surfaces of the display and of the electrical tinting film and/or of the electrical tinting film and the cover surface.

### BRIEF DESCRIPTION OF DRAWINGS

Other details, features and advantages of embodiment of the disclosure result from the following description of exemplary embodiments with reference made to the associated drawings. In the drawings:

FIG. 1 shows a basic construction of a display arrangement according to the disclosure in a lateral view,

FIG. 2 shows a display arrangement according to FIG. 1 in a perspective view in a voltage-free state,

FIG. 3 shows a display arrangement according to FIG. 1 in a perspective view in a turned-on state, and

FIG. 4 shows the display arrangement with a view of information on the display.

### DETAILED DESCRIPTION

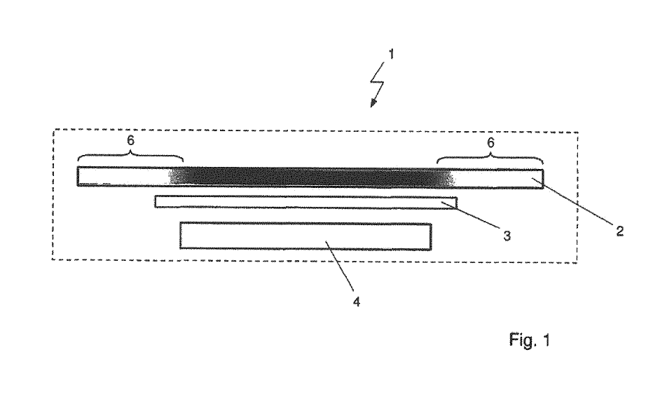

FIG. 1 shows the basic construction of the display arrangement 1 according to the disclosure in a lateral view. A transparent, electrical tinting film 3 is arranged underneath a cover surface 2 which is arranged facing an observer who is not shown. This tinting film 3 has the quality of appearing in a color, for example, white in a voltage-free state, that is, without an applied external voltage. If a voltage is applied to the tinting film 3, the displayed image of white changes into a transparent state. In order to make available the voltage required for the electrical tinting film 3, an arrangement customary from the prior art for making an output voltage available can be used. The controlling of the arrangement can take place by a central control arrangement which also controls, for example, the display.

In this case the observer of the display arrangement 1 can see through the cover surface 2 and the electrical tinting film 3.

Such electrical tinting films 3 comprise at least one layer in their construction which changes under the influence of an electrical voltage or the action of an electrical field, for example, the alignment of its constituents such as liquid crystals or liquid crystal molecules and therefore scatters or deflects the light beams striking the film in the voltage-free state and allows them to pass with an applied voltage.

A display 4 known from the prior art and for displaying or showing any information is arranged under the electrical tinting film 3. The display 4 can be constructed as a liquid crystal display, abbreviated as LCD display for English “liquid crystal display”, a TFT display for English “thin film transistor”, an OLED display operated by organic light-emitting diodes and for English “organic light-emitting diode” or as another display suitable for displaying information.

In a turned-off state the display arrangement 1 appears in a white design for the case that a white electrical tinting film 3 is arranged. If another color, for example blue is used for the electrical tinting film 3, then the display arrangement 1 appears in the turned-off state in a blue design. If information is displayed on the display 4, the information cannot be recognized through the white or blue electrical tinting film 3 dense to the view of an observer.

If a voltage is placed on the electrical tinting film 3, the film 3 changes its qualities from non-transparent to transparent. In this state the display 4 arranged under the tinting film 3 and the information displayed on the display 4 can be recognized well by an observer.

A special embodiment of the present disclosure provides shaping the cover surface 2 in such a manner that the optical qualities change from the center of the cover surface 2 outward toward the edge of the cover surface 2. Whereas the ability to see through the cover surface 2 is the greatest in the center, the ability to see through it in the direction of the edge of the cover surface 2 constantly decreases and merges into an increasingly white color tone.

As a result of this change of the optical qualities of the cover surface 2, an edge area 6 is formed which appears to be white and almost opaque. Depending on the shape of the change of the optical qualities, an edge area 6 can be formed which is elliptical or rectangular, wherein the edge area 6 does not adversely affect the information displayed on the display 4. This can be ensured, for example, in that the edge area 6 is formed in an area into which the display 4 does not extend with its dimensions.

This change of the optical qualities of the cover surface 2 along an imaginary stretch starting from the center of the cover surface 2 can take place in a linear or non-linear manner. In addition, different stretches running in rays from the center can have different changes of the optical qualities. It is advantageous to select the gradients in such a manner that the edge area 6 forms an ellipse or ideally almost a rectangle, wherein the transparent area is not greater than the dimensions of the display 4 arranged underneath it.

This quality can be used especially advantageously for the case that the electrical tinting film 3 and possibly also the display 4 are smaller in their particular dimensions than the cover surface 2, as is shown in FIG. 1.

This linear or non-linear change of the optical qualities of the cover surface 2 is made available in such a manner that the display arrangement 1 is perceived in a white color tone even outside of the dimensions of the tinting film 3. On the other hand the change of the optical qualities in the area of the display 4 is to be designed in such a manner that the display 4 can shine through the cover surface 2 sufficiently well for a qualitatively sufficient representation.

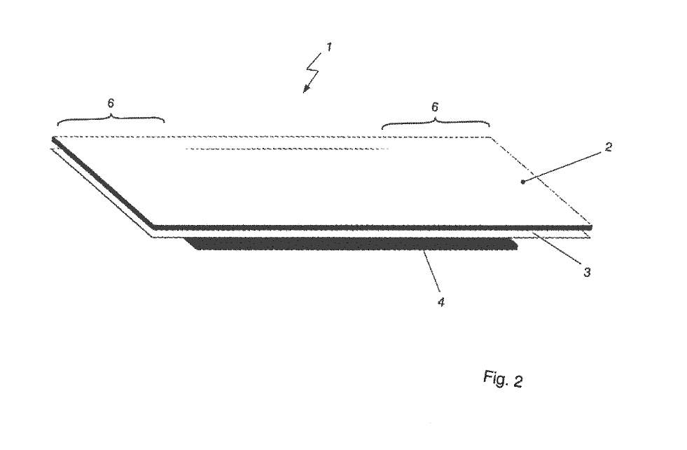

In FIG. 2 the display arrangement 1 according to FIG. 1 is shown in a perspective view in a voltage-free state. The changing optical quality is shown in the cover surface 2. Whereas the cover surface 2 appears completely transparently in the middle, the edge areas 6 of the rectangular cover surface 2 are not transparent. In the example in which a white tinting film 3 is used these edge areas 6 should assume a white color.

Under the cover surface 2 the electrical tinting film 3 can be seen at least partially, which appears white in the voltage-free state and prevents the display 4 arranged underneath it from shining through, as is shown in FIG. 2.

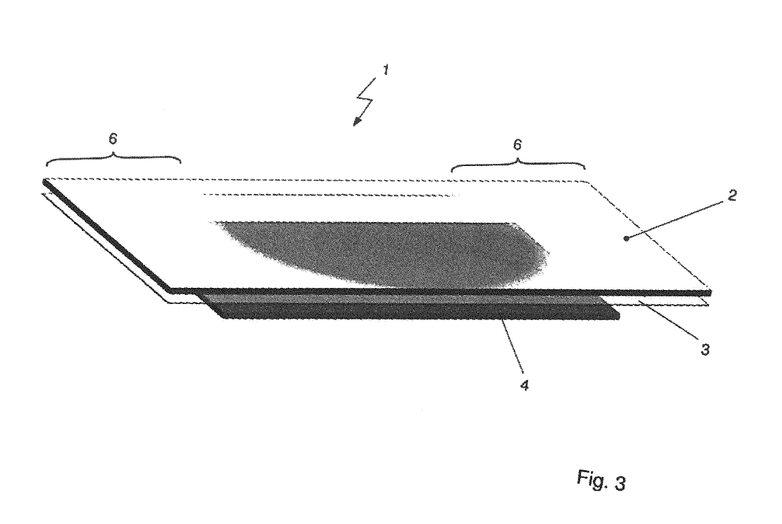

When an appropriate voltage is applied on the electrical tinting film 3 the tinting film 3 becomes transparent. The display arrangement 1 changes its appearance image from a purely white representation to a representation in which the display 4 can be seen by the observer. This state is shown in FIG. 3. The display arrangement 1 can also show a white frame in the outer edge area 6 while in the area of the display 4 the information displayed for the observer, such as a driver of a motor vehicle, can be displayed without a reduction of the quality of the display.

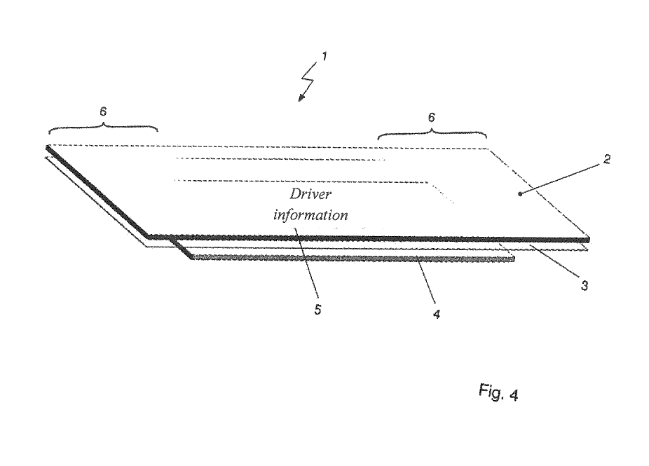

FIG. 4 shows the display arrangement 1 with a view of information 5 which is displayed by the display 4. Since an electrical field is generated on the electrical tinting film 3 by applying a voltage and the tinting film 3 therefore is transparent, the observer can recognize the information displayed on the display 4 without loss, that is, in a high optical quality in the display arrangement 1.

Various types such as an LCD display, an OLED display or a TFT display can be used as display 4. However, there is no limitation to these display types.

We claim:

1. A display arrangement, comprising:
a display to display information;
a cover surface arranged above a surface of the display; and
electrical tinting film is provided between the display and the cover surface,
wherein the electrical tinting film is white without an applied voltage, is transparent with an applied voltage.

2. The display arrangement according to claim 1, characterized in that the display is a TFT display or an LCD display or an OLED display.

3. The display arrangement according claim 1, wherein the cover surface comprises an opaque edge area.

4. The display arrangement according claim 2, wherein the cover surface comprises an opaque edge area.

5. The display arrangement according to claim 4, wherein the edge area has the shape of a rectangle or of an ellipse.

6. A method for displaying information via a display, comprising:
providing a display to display information;
providing a cover surface arranged above a surface of the display; and
providing an electrical tinting film is provided between the display and the cover surface,
in response to the display being turned off, disconnecting an externally applied voltage to the electrical tinting film; and
in response to the display being turned on, connected an externally applied voltage to the electrical tinting film.

7. The method according to claim 6, wherein the display is made available as a TFT display or an LCD display or an OLED display.

8. The method according to claim 6, wherein the electrical tinting film is made available in a white color tone.

9. The method according to claim 6, wherein the cover surface is made available above a surface of the electrical tinting film, which surface faces away from the display.

10. The method according to claim 9, wherein the cover surface is made available in such a manner that it comprises a transparent, central area and an opaque edge area made available on the edge of the cover surface.

11. The method according to claim 10, wherein the edge area of the cover surface has an elliptical or rectangular shape.

12. The method according to claim 6, wherein the display and the electrical tinting film and/or the electrical tinting film and the cover surface are connected to each other using an optical bonding method.
